(19) United States
(12) Patent Application Publication
(10) Pub. No.: US 2026/0231136 A1
(43) Pub. Date: Aug. 6, 2026

(54) SHORT DEVICE IDENTIFIER FOR WIRELESS COMMUNICATION DEVICE OPERATING IN A DISCONNECTED MODE

(71) Applicant: Sony Group Corporation, Tokyo (JP)

(72) Inventors: Nafiseh Seyed MAZLOUM, Lund (SE); Basuki PRIYANTO, Lund (SE); Anders BERGGREN, Lund (SE); Torgny PALENIUS, Barsebäck (SE)

(21) Appl. No.: 19/151,572

(22) PCT Filed: Feb. 14, 2024
(86) PCT No.: PCT/EP2024/053683

§ 371 Date: Jul. 28, 2025

(30) Foreign Application Priority Data
Feb. 16, 2023 (SE) 2350154-7

(51) Int. Cl. H04W 72/044

(52) U.S. Cl. CPC H04W 72/046

(57) ABSTRACT

A device identifier for uniquely identifying wireless communication devices registered in a cellular network is disclosed. The device identifier has a limited spatial validity. The device identifier is valid in association with one or more reference signals that are transmitted on one or more beams of the cellular network.

### TECHNICAL FIELD

Various examples of the disclosure generally pertain to wake-up procedures for waking-up wireless communication devices registered in a cellular network. Wake-up procedures include a transmission of a trigger signal from a cellular network towards a wireless communication device. The trigger signal includes a device identifier allocated to the wireless communication device. According to examples of the disclosure, the device identifier is valid in association with one or more reference signals that are transmitted on one or more beams of a cellular network.

### BACKGROUND

Energy efficiency is a key design requirement for wireless communication devices (UEs) with limited energy resource, e.g., UEs using small rechargeable and single coin cell batteries. To reduce power consumption at UEs, UEs operate in a connected mode when there is data to be transmitted to or from the UE; and operate in a disconnected mode when there is no data to transmit. When operating in the disconnected mode, a data connection between the UE and the cellular network is not currently maintained. The UE is typically reachable only during certain time intervals during which a receiver of the UE is transitioned into an active state to monitor for signals transmitted by the cellular NW to reach the UE. The cellular NW uses these signals to trigger an action at the UE, e.g., to trigger that the UE reestablishes the data connection to transition from the disconnected mode to a connected mode. The corresponding procedure is referred to as “wake-up procedure”, hereinafter.

An example of a wake-up procedure is the 3GPP paging procedure. For instance, the Third Generation Partnership Project (3GPP) has specified, in Technical Specification (TS) 38.300, Version 16.8.0 (2021 December), section 9.2.5 a paging procedure. Here, for a UE operating in the Radio Resource Control (RRC) modes RRC_IDLE or RRC_INACTIVE (as examples of disconnected modes), the cellular network transmits paging indicators and paging messages. The paging procedure for waking-up a particular UE requires a multi-step communication before that UE can determine whether the cellular network intended to reach that particular UE (or another UE, e.g., sharing a certain paging occasion). The unique device identifier (ID), carried in paging message, is typically a device Temporary Mobile Subscriber Identity (TMSI) or 5G-S-TMSI with length 48 bits, or an I-Radio Network Temporary Identifier (I-RNTI) with 40 bits when in INACTIVE. Due to its lengthy size, the unique device ID cannot be directly communicated to the UE and therefore the resources for the paging messages needs to be scheduled and indicated to the UE via paging indicator (paging Downlink Control Information, paging DCI) in advance. The paging message is transmitted on a high-bandwidth Physical Downlink Shared Channel (PDSCH). In further detail, the UE and a base station (BS) implement a two-step paging procedure, e.g., when there is a data available from BS to the UE. The UE monitors its Paging Occasion (PO) and listen for the paging DCI on the Physical Downlink Control Channel (PDCCH). The paging DCI is scrambled with a paging operation identity, i.e., the P-RNTI. If a DCI is decoded, the UE will follow up and listen for subsequent paging message, to check if the attached paging record contains the unique device ID allocated to the UE. Only if the paging message carries this unique device ID, the UE takes a further action, e.g., initiates a random-access procedure (RACH procedure).

Blind decoding of the paging DCI transmitted on the PDCCH is comparatively energy intensive.

To mitigate this, a three-step wake-up procedure is introduced in 3GPP Rel-17. The UE first monitors the PDCCH for the paging early indicator with DCI format 2-7, scrambled with the group identity PEI-RNTI. This is described in 3GPP TS 38.212, section 7.3.1.3.8, The PEI-RNTI is not a unique device identifier; but rather indicates a group of UEs. It is a group indicator. Only if the PEI is detected, the UE continues to monitor and decode for paging DCI and subsequently for the paging message where the intended UE can find its unique device ID. Such three-step wake-up procedure reduces both idle channel monitoring and the false wake-up, since a PEI has a shorter time and also smaller group of UEs that belong to the same paging occasion are woken up.

Compared to normal paging, the PEI includes some knowledge about UE device ID, not the exact identity but the group in which a specific UE has been grouped into. In the extreme case, the group would only consist of one UE, hence reducing overhearing/false wake-up to zero. Currently the max number of subgroups is 8, i.e., reducing overhearing with a factor of 8. But to uniquely address a single UE, the number of bits would increase. Since the max number of groups are 8, it would be enough to use 3 bits the address the group. Currently the number of bits defined for DCI format 2-7 has a payload size of 43 bits.

Accordingly, using a group ID such as the PEI has restrictions and drawbacks in relation to the flexibility to wake up individual UEs from the disconnected mode. Also, using a group ID such as the PEI requires multiple steps in the wake-up procedure so that it is associated with increased energy consumption.

To reduce the energy consumption further, the concept of extra low-power wake-up receivers has been introduced. A use of Low Power Wake Up Receiver (LP-WuRx), in addition to the main radio, where the LP-WuRx listens for potential downlink communication from the cellular network, can reduce the power consumption when the UE is in the disconnected mode significantly.

### SUMMARY

Accordingly, there is a need for advanced wake-up procedures. Specifically, there is a need for wake-up procedures that reduce or mitigate the above-identified restrictions or drawbacks.

This need is met by the features of the independent claims. The features of the dependent claims define embodiments.

Hereinafter, techniques of employing a local device ID are disclosed. The local device ID is valid as long as one or more criteria are met. Such criteria can include, but are not limited to the spatial context and/or a temporal validity. The local device ID is uniquely and temporarily associated with a UE in a certain spatial context according to examples. The certain spatial context is, in some examples of the disclosure, defined with respect to transmission of a reference signal (RS; sometimes also referred to as pilot signals or pilot tones) on one or more beams of a cellular network. This local device ID can be assigned to a UE by the cellular NW or locally determined at the UE.

A method for use in a UE registered to a cellular network based on a first device identifier is disclosed. The method includes establishing a second device identifier valid in a spatial context defined locally within the cellular network. The method also includes, when operating in a disconnected mode, determining whether one or more trigger signals transmitted by the cellular network comprises the second device identifier. The method further includes responsive to determining that the one or more trigger signals comprise the second device identifier, taking an action triggered by the trigger signals.

According to some examples of the disclosure, the spatial context is defined by the UE being located in one or more cells of the cellular network having a certain identity. According to some examples of the disclosure, the spatial context is defined by the UE being able to receive one or more broadcasted reference signals having a certain identity.

According to some examples of the disclosure, the one or more broadcasted reference signals are of multiple types such as positioning reference signal and synchronization signal block, or synchronization signal block and channel state information reference signal.

According to some examples of the disclosure, the spatial context is defined by the UE being located in a geofenced area.

According to some examples of the disclosure, the spatial context is defined by the UE being served via a given repeater device.

According to some examples of the disclosure, the spatial context is defined by the UE being served via a given coverage enhancing device of the cellular network.

According to some examples of the disclosure, the spatial context is defined by the UE being served via a given pico BS of the cellular network.

According to some examples of the disclosure, the spatial context is defined by the UE remaining stationary.

A method for use in a UE is disclosed. The UEs registered in a cellular network based on a first device identifier. The method includes obtaining a second device identifier. The second device identifier is valid in association with one or more reference signals. The one or more reference signals are transmitted on one or more beams of the cellular network. The second device identifier is different than the first device identifier. The method further includes monitoring whether a signal is indicative of the second device identifier. The signal is transmitted by the cellular network. Said monitoring is upon the UE being located in coverage of at least 1 of the one or more beams on which the one or more reference signals are transmitted. Said monitoring is while the UE operates in a disconnected mode. The method further includes, upon detecting that the signal is indicative of the second device identifier, taking an action associated with the signal.

A UE configured to register in a cellular network based on a first device identifier is disclosed. The UE includes at least one processor and a memory. The at least one processor is configured to load program code from the memory and to execute the program code. The at least one processor, upon loading and executing the program code, is configured to obtain a second device identifier. The second device identifier is valid in association with one or more reference signals. The one or more reference signals are transmitted on one or more beams of the cellular network. The second device identifier is different than the first device identifier. The at least one processor is further configured to monitor whether a signal is indicative of the second device identifier. The signal is transmitted by the cellular network. Said monitoring is upon the UE being located in coverage of at least 1 of the one or more beams on which the one or more reference signals are transmitted. Said monitoring is while the UE operates in a disconnected mode. The at least one processor is further configured to take an action associated with the signal upon detecting that the signal is indicative of the second device identifier.

A method for use in a node of a cellular network is disclosed. A UEs registered to the cellular network based on a first device identifier. The method includes determining a second device identifier for the UE. The second device identifier is valid in association with one or more reference signals that are transmitted on one or more beams of the cellular network. The second device identifier is different than the first device identifier. The method further includes triggering one or more transmissions of a signal. The signal is indicative of the second device identifier. The signal is triggered to be transmitted on a least one of the one or more beams. The signal triggered to be transmitted while the UE operates in a sleep mode.

A node of a cellular network is disclosed. A UEs registered to the cellular network based on a first device identifier. The node includes at least one processor and a memory. The at least one processor is configured to load program code from the memory and to execute the program code. The at least one processor, upon loading and executing the program code, is configured to determine a second device identifier for the UE. The second device identifier is valid in association with one or more reference signals that are transmitted on one or more beams of the cellular network. The second device identifier is different than the first device identifier. The at least one processor is further configured to trigger one or more transmissions of a signal. The signal is indicative of the second device identifier. The signal is triggered to be transmitted on a least one of the one or more beams. The signal triggered to be transmitted while the UE operates in a sleep mode.

A computer program including program code is disclosed. The program code can be loaded by at least one processor and the at least one processor can execute the program code. The at least one processor, upon loading and executing the program code, performs methods as disclosed above.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular network according to various examples.

FIG. 2 schematically illustrates a UE that can connect to and register in the cellular network according to various examples.

FIG. 3 schematically illustrates a BS of a radio-access network of the cellular network according to various examples.

FIG. 4 is a flowchart of a method for use in a UE according to various examples.

FIG. 5 is a flowchart for use in the BS according to various examples.

FIG. 6 schematically illustrates a deployment scenario of multiple UEs associated with the same single device identifier according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Wake-up procedures are disclosed. The wake-up procedure includes a cellular network (NW) reaching a UE that operates in a disconnected mode. The UE is registered in the cellular NW. The wake-up procedure includes UE attempting to receive (monitoring for) one or more signals to determine whether the cellular NW intends to reach the UE.

Upon the UE detecting that such signal directed to that UE (rather than to another UE), the UE takes an appropriate action. Thus, such signal triggers at least one action. Examples of such actions that can be triggered by such signal include: system information block update; transitioning to a connected mode; performing a random-access procedure; transmitting uplink reference signals; etc.

Such signal that reaches the UE when operating in the disconnected mode triggers the UE to take an action can, accordingly, be referred to as trigger signal.

For example, such signal can be a wake-up signal that is received by a Lp-WuRX. The signal can also be received by a main radio of the UE that is also used for communicating data while operating in the connected mode. However, hereinafter, techniques will be primarily described in the context of an implementation of the signal triggering the UE to take an action while operating in the disconnected mode as a wake-up signal (WUS). Similar techniques can be readily applied to other forms of trigger signals, including those that are received by the main radio.

According to examples, the disconnected mode is one of the following: RRC_Idle; RRC_Inactive. The disconnected mode is distinct from a connected mode. During the connected mode, the UE maintains a data connection with the cellular NW. When operating in the connected mode, the UE employs its main radio to transmit signals and/or receive signals. According to disclosed examples, a UE is a low-power UE such as those described in 3GPP Technical Requirement (TR) TR 38.875 V17.0.0 (2021 March). Energy efficiency is a key design requirement for UEs with limited energy resource, e.g., UEs using small rechargeable and single coin cell batteries. Among use cases, sensors and actuators are deployed extensively for monitoring, measuring, charging, etc. Generally, their batteries are not rechargeable and expected to last at least a few years as described id. Wearables include smart watches, rings, eHealth related devices, and medical monitoring devices. With typical battery capacity, it is challenging to sustain up to 1-2 weeks as required.

According to disclosed examples, a UE includes a very limited energy resources. The energy resource can have a lifetime of a few years.

According to disclosed examples, a UE may not include a battery or include an extremely limited battery capacity. Such UE typically obtains the energy by harvesting energy from the surroundings (e.g., solar cells, vibration, radio-wave, etc).

According to disclosed examples, a UE is one of the following: a smart watch, a smart rings, an eHealth related device, IoT sensors, or a medical monitoring devices.

According to the disclosed examples, a WUS used in a wake-up procedure is indicative of a device ID. For example, a bit sequence of the WUS can be scrambled with the device ID or a bit sequence of WUS is encoded via a simple spreading using device ID. The WUS does not need to carry the device ID in all scenarios. For instance, it would also be possible that the time and/or frequency resources of the WUS are determined based on the device ID. Here, the WUS is implicitly indicative of the device ID.

The device ID identifies a certain UE uniquely if one or more criteria are met. I.e., the device ID allows to uniquely discriminate between any two UEs. A device ID is generally distinct from a group identifier. A group identifier is intended to address a group of UEs. An example group identifier is carried by the Machine Type Communicate wake-up signal (MWUS) as described in 3GPP TS 36.211 V17.0.0 (2021 December), section 6.11B.

According to the disclosed examples, a WUS used in a wake-up procedure is indicative of a device ID that is not globally unique. Such a globally unique device ID (global device ID) would ensure that any given UE registered in the cellular NW—upon receiving the WUS that includes the globally unique device ID—can unambiguously determine that the cellular NW intends to reach that particular UE (or rather another UE)—irrespective of the location of the UE in the cellular NW.

Various techniques are based on the finding that, due to the large number of UEs that are potentially registered in a cellular NW, providing a unique device ID valid globally or at least in a comparatively large area of the cellular NW, e.g., many cells, requires that such device ID is comparatively long. Examples of long legacy device IDs include the TMSI or 5G-S-TMSI with length 48 bits, and an I-RNTI with 40 bits. The TMSI and I-RNTI are included in paging messages communicated on the Physical Downlink Shared Channel (PDSCH) on respective time-frequency resources that are allocated by the paging DCI. The comparatively long length of such legacy device IDs makes it challenging to implement a wake-up procedure based on WUSs having a comparatively simple modulation. This is because the bit rate of such WUSs is limited. This can be due to the modulation employed, e.g., on-off-keying. Then, to accommodate for legacy device IDs, such WUSs would become impractically long. On the other hand, using a complex modulation—e.g., Quadrature Phase Shift Keying or M Quadrature and Amplitude Modulation, Orthogonal Frequency division multiplexing—may not be possible when intending to use an LP-WuRx for monitoring for the WUSs.

To mitigate this, according to the disclosure, a local device ID is used. The local device ID is not globally valid throughout the entire cellular NW. The local device ID also uniquely identifies a UE. The local device ID is not a group ID. The local device ID is valid only in a certain spatial context. Then, since a smaller number of UEs is situated in the spatial context than in the entire cellular NW, the length of the local device ID can be shorter while still avoiding ambiguities.

The local device ID may have a length of not more than 10 information bits, optionally or preferably of not more than 5 information bits, further optionally of 3 information bits.

The local device ID may be a radio node ID, i.e., assigned and maintained by the radio-access network (RAN) of a cellular NW. Alternatively, the local device ID may be exposed to or even assigned by the core network of the cellular NW.

The local device ID can be temporarily associated with a UE—i.e., may not be permanently assigned to a UE. The local device ID can be updated from time to time. The local device ID can be updated if it does not meet the validity criteria, such as the UE changes its spatial context. The local device ID can be updated if the UE (re-)registers in the cellular NW. According to examples, local device ID is valid in association with one or more RSs that are transmitted on one or more beams of the cellular NW. This means that the spatial context is defined via certain RSs that are transmitted on one or more specific beams of the cellular NW. If the UE moves out of coverage of the one or more beams on which the certain RSs are transmitted, then the UE cannot assume that the local device ID remains valid.

The local device ID being valid means that the UE is only allowed to use/rely on the local device ID as long as one or more validity criteria are fulfilled. The UE cannot expect the local device ID to be intended for that UE if the one or more validity criteria are not fulfilled anymore. Such techniques enable to implement a wake-up procedure that includes transmission of a WUS early on during the wake-up procedure—e.g., as the first downlink (DL) message of the wake-up procedure—that includes the WUS. A one-step wake-up procedure becomes possible where the cellular NW only transmits a single WUS that includes or is otherwise indicative of the local device ID; and the UE then directly takes the appropriate action such as performing a RACH procedure, performing system information block (SIB) updated reception.

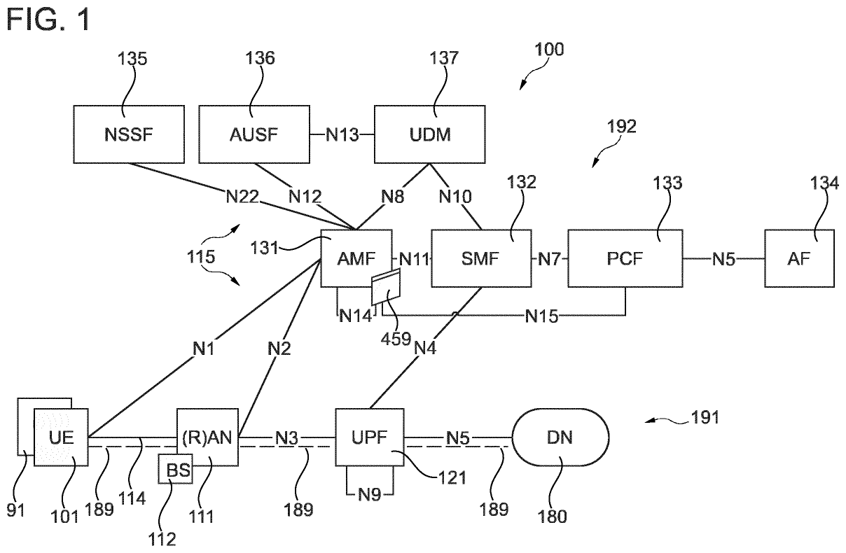

FIG. 1 schematically illustrates a cellular NW 100. The example of FIG. 1 illustrates the NW 100 according to the 3GPP 5G architecture. Details of the 3GPP 5G architecture are described in 3GPP TS 23.501, version 17.0.0 (2021 Mar. 30).

In the scenario of FIG. 1, a UE 101 is connectable to the cellular NW 100. A further UE 91 is also illustrated.

The UEs 91, 101 are connectable to the NW 100 via a RAN 111, typically formed by one or more BSs 112 (only a single BS 112 is illustrated in FIG. 1 for sake of simplicity; the BSs implement Ans). A wireless link 114 is present towards the RAN 111—specifically between one or more of the BSs 112 of the RAN 111—and the Ues 91, 101.

The RAN 111 is connected to a core NW (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW 180, e.g., the Internet or a Local Area NW. Application data can be communicated between each one of the Ues 91, 101 and one or more servers on the data NW 180. The application data is communicated when the Ues 91, 101 operate in a connected mode—rather than in a disconnected mode.

The NW 100 also includes an Access and Mobility Management Function (AMF) 131; a Session Management Function (SMF) 132; a Policy Control Function (PCF) 133; an Application Function (AF) 134; a NW Slice Selection Function (NSSF) 134; an Authentication Server Function (AUSF) 136; a Unified Data Management (UDM) 137; and a Location Management Function (LMF) 139. FIG. 1 also illustrates the protocol reference points N1-N22 between these nodes.

The AMF 131 provides one or more of the following functionalities: registration management; NAS termination; connection management; reachability management; mobility management; access authentication; and access authorization. A data connection 189 is established by the AMF 131 if the respective UE 91, 101 operates in a connected mode.

For instance, the AMF 131 may maintain a registry of UEs registered in the cellular NW. The AMF 131 can maintain a list of respective device IDs 459—e.g., global device IDs—such as TMSI (specifically 5G-S-TMSI) or 5G-Globally Unique Temporary ID (GUTI). The AMF 131 may also maintain a list of other temporary device IDs, e.g., local device IDs that are valid in a certain spatial context, e.g., valid in association with RSs transmitted one or more beams.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

A respective data connection 189 can be established between each one of the Ues 91, 101 via the RAN 111 and the data plane 191 of the CN 115 and towards the DN 180. For example, a connection with the Internet or another packet data NW can be established.

The data connection 189 is established between the UE 101 and the radio access network 111 when the UE 101 operates in the connected mode. The data connection 189 is not established between the UE and the radio access network 111 when the UE 101 operates in a disconnected mode such as RRC_Idle or RRC_Inactive.

When the UE operates in the disconnected mode, a wake-up procedure can be executed to reach the UE and trigger an action such as establishing the data connection 189. The wake-up procedure can be triggered by the RAN 111 or the CN 115 (via the RAN 111). The wake-up procedure can be triggered by, e.g., DL data scheduled for transmission to the UE or a need to localize the UE.

To establish the data connection 189, it is possible that the respective UE 91, 101 performs an initial access procedure, specifically a RACH procedure.

A server of the DN 180 may host a service for which payload data is communicated via the data connection 189. The data connection 189 may include one or more bearers such as a dedicated bearer or a default bearer. The data connection 189 may be defined on the Radio Resource Control (RRC) layer, e.g., generally Layer 3 of the OSI model of Layer 2.

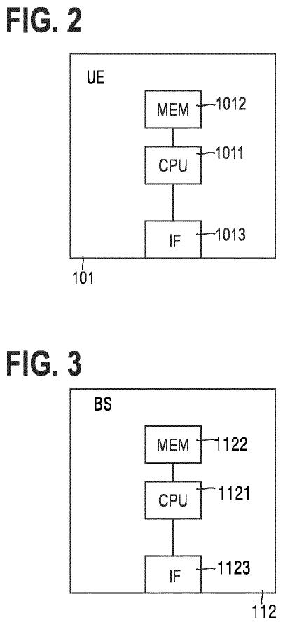

FIG. 2 schematically illustrates aspects in connection with the UE 101. The UE 101 includes a processor 1011 and a memory 1012. The UE also includes a communication interface 1013. The communication interface implements a communication protocol stack. The UE can communicate on the wireless link 114 using the communication interface 1013. The processor 1011 can load program code from the memory 1012 and execute the program code. Upon loading and executing the program code, the processor 1011 performs techniques as disclosed herein, such as: registering and the cellular NW 100; using multiple device ID; participating in a wake-up procedure, e.g., by monitoring for WUS, detecting a device ID included in a received WUS, and/or taking subsequent action; operating in a disconnected mode; operating in a connected mode; transitioning between operating in the disconnected mode and operating in the connected mode; etc.

FIG. 3 schematically illustrates aspects in connection with the BS 112. The BS 112 includes a processor 1121 and a memory 1122. The BS 112 also includes a communication interface 1123. The communication interface 1123 implements a communication protocol stack. The BS 112 can communicate on the wireless link 114 using the communication interface 1123. Also, communication towards one or more nodes of the cellular NW 100 can be executed. The processor 1121 can load program code from the memory 1122 and execute the program code. Upon loading and executing the program code, the processor 1121 performs techniques as disclosed herein, such as: registering multiple UEs in the cellular NW; allocating device IDs to UEs; reusing local device IDs in multiple spatial contexts; participating in a wake-up procedure of a UE; transmitting WUSs; etc.

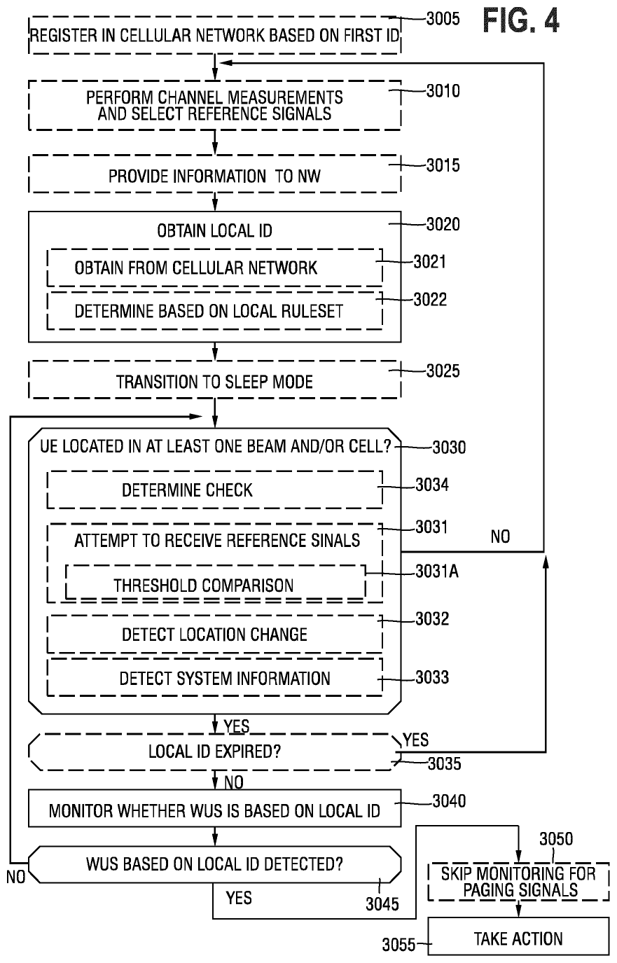

FIG. 4 is a flowchart of a method according to various examples. In FIG. 4, optional boxes are shown with dashed lines.

The method of FIG. 4 is for use in a UE. For example, the method of FIG. 4 can be used in the UE 101 (cf. FIG. 1). The method of FIG. 4 can be executed by the processor 1011 upon loading and executing program code from the memory 1012 (cf. FIG. 2).

The method of FIG. 4 generally pertains to UE behavior in a wake-up procedure.

At box 3005, the UE is registered in a cellular NW based on a first device ID.

Registering the cellular NW includes, in some disclosed examples, transmitting a registration request and obtaining a response message indicative of the first device ID. The first device ID can also be hardcoded into the UE.

According to examples, the first device ID is 3GPP TMSI. See 3GPP TS 23.003 V17.8.0. According to examples, the first device ID is 3GPP International Mobile Subscriber Identity (IMSI). See 3GPP TS 23.003 V17.8.0.

According to examples, the first device ID is 3GPP Radio NW Temporary Identifier (RNTI). See 3GPP TS 38.321 V17.2.0.

According to examples, the first device ID is globally valid throughout the cellular NW. This means that each first device ID is assigned to only a single UE at most by the cellular NW. There is no ambiguity between first device IDs from UE perspective.

At box 3010, the UE performs channel measurements and selects Reference Signals, RSs based on the channel measurements. The UE performs channel measurements based on a plurality of RSs transmitted by the cellular NW on a plurality of beams and selects one or more RSs from the plurality of RSs based on the channel measurements. BSs of the cellular NW transmit RSs on the plurality of beams, e.g., at predefined time-frequency resources.

By performing the channel measurements and selecting RSs, the UE determines its spatial context. This is because certain RSs are only received by the UE when it is located at certain positions throughout the cellular NW. The UE determines the one or more beams having a coverage including the position of the UE.

The one or more beams, according to examples, form a subregion of a single cell of the cellular NW. The one or more beams, according to other examples, form a subregion of two or more cells. This means that multiple BSs of multiple cells transmit the RSs.

As a general rule, a “beam” within the meaning of the disclosure is a volume, e.g., a cone, cylinder or ellipsoid. In detail, a beam has a certain coverage and this coverage is a volume. A “beam” within the meaning of the disclosure is a signal transmitted in a coverage volume delimited by the beam. A beam can have a certain beam identity. A beam of the cellular NW can be defined by certain transmit precoding employed, spatial filter by a given BSs of the cellular NW. A beam can have a certain beam profile that is obtained through the beamforming defined by the transmit precoding. A beam can have a beam width and a beam direction at which the maximum signal amplitude is observed.

At box 3010, the UE, in some examples of the disclosure, selects the N strongest RSs of all RSs that it has received. For instance, N=1 or N=2.

In a further example, at box 3010, the UE selects one or more RSs that have a received signal strength that is above a predefined threshold.

As a general rule, according to the disclosed examples, different types of RSs can be used by the UE to make a selection at box 3010. Different types of RSs can be used to define a spatial context. For instance, 3GPP Synchronization Signal Blocks (SSBs) or Channel State Information RSs (CSI-RS) can be used. See 3GPP TS 38.211, version 17.4.0, section 7.4.2 and 7.4.1.5, respectively Other examples are Tracking RSs (TRS) and Positioning RSs (PRS). See 3GPP TS 38.211, version 17.4.0, section 7.4.1.5 and 7.4.1.7, respectively. They can be also low-power synchronization or low-power reference signals designed to be received by the low-power receiver.

Multiple CSI-RSs are typically associated or quasi-co-located with an SSB. A CSI-RS can be covering a smaller area than an SSB.

As a general rule, the plurality of RSs can be transmitted in multiple bursts by a certain BS, wherein each burst includes transmission on multiple beams.

According to examples, the one or more RSs that are selected by the UE are identified by at least one of one or more identifiers included in the one or more RSs. This means that each one of the selected one or more reference signals can include an information element that specifies an identity and this identity can identify the respective RS, e.g., at least locally within a certain cell of the cellular NW. Different RSs thus include different identifiers. Different RSs that are transmitted on different beams (and thus define different spatial contexts) of the same type then carry different identifiers. RSs having different identities can be transmitted on different beams.

Alternatively or additionally, according to examples, the one or more RSs that are selected by the UE are identified by pre-allocated time-frequency resources on which the one or more RSs are transmitted. The time-frequency resources may thus be uniquely allocated to each one of the one or more RSs. Such allocation can be executed by a system information broadcasted in cells of the cellular NW. Such allocation can also be fixed by a communication protocol.

The UE can perform the channel measurements at box 3010 while operating in a disconnected mode, e.g., the 3GPP RRC_Idle or RRC_Inactive. The UE alternatively performs the channel measurements at box 3010 while operating in a connected mode in which a data connection with the cellular NW is established, e.g., 3GPP RRC_Connected.

The UE can, in a first example implementation of at box 3010, select multiple RSs of multiple types, e.g., the strongest SSB and the strongest PRS. The UE can, in a second example implementation of box 3010, select multiple RSs of the same type. For instance, the UE can select the strongest received SSB of a burst and the second-strongest received SSB of a burst. Combinations of these two examples are possible.

Above scenarios have been disclosed according to which the UE selects one or more RSs. The UE can alternatively or additionally also select one or more cells of the cellular NW. For instance, the UE can select the N cells having the strongest signal, wherein N=1 or N=2, etc. For N>2, neighbor cell measurements can be performed, beyond the cell that the UE is currently camping on.

The selection of one or more cells can be combined with the selection of one or more RSs. For instance, the UE may select multiple RSs originating from at least two cells. The UE may select multiple RSs and determine the one or more BSs and cells that transmit the RSs.

At box 3015, the UE provides the information associated with the selected one or more RSs of box 3010 to the cellular NW. The information can alternatively or additionally include selected on or more cells.

The UE can provide this information as a mobile-originating early data transfer as part of a random-access procedure. This enables the UE to provide the information while operating in the disconnected mode, without being required to transition to the connected mode. The UE can, alternatively, provide this information as a RRC control message when the UE operates in the connected mode.

In a concrete example implementation of box 3010 and box 3015, the UE finds the best cell or its serving cell, i.e., finds the cell ID and SSB-ID. The UE transmit this information to its serving cell via RACH. After this the cellular NW assigns a local device ID to this UE. With this, the NW avoids assigning the same local device ID to multiple Ues listening to the same SSB-ID.

This is explained in box 3020.

At box 3020, the UE obtains a second device ID. The second device ID is different than the first device ID based on which the UE is registered in the cellular NW (as explained above in connection with box 3005).

The second device ID will be referred to as local device ID, hereinafter. The local device ID is valid in association with the one or more RSs transmitted on the one or more beams of the cellular NW as selected at box 3010.

The local device ID being “valid” means that the UE is only allowed to use/rely on the local device ID as long as one or more validity criteria are fulfilled. The UE cannot expect the local device ID to be intended for that UE if the one or more validity criteria are not fulfilled anymore.

The first device ID is, according to examples, longer, in terms of information bits, than the local device ID. In other words, the first device ID includes an information bit or information character sequence that is longer than a information bit or information character sequence of the local device ID. The total length of the local device ID—e.g., including redundancy or error protection bits—can be longer or shorter than the total length of the first device ID.

In a first example implementation of box 3020, obtaining the local device ID includes—at box 3021—obtaining the local device ID or at least a part thereof from the cellular NW. A respective control message is received from the cellular NW that is indicative of the at least parts of the local device ID. For example, the UE obtains the local device ID at box 3020 responsive to providing the information to the cellular NW at box 3015. The local device ID or the part thereof is obtained, in examples, as mobile-terminating early data transmission during a random-access procedure by the UE to the cellular NW. This enables the UE to obtain the local device ID from the cellular NW without completing a transition to the connected mode.

In a second example implementation of box 3020, obtaining the local device ID at box 3020 includes—at box 3022—determining at least a part of the local device ID based on a local ruleset.

This means that the UE can locally determine the at least parts of the local device ID based on calculations and/or algorithms executed locally, e.g., without requiring input from the cellular NW or without receiving respective control messages from the cellular NW.

According to examples, the local device ID is generated based on a certain function and the input(s) to the function can be one or more of the following: the first device ID, e.g, TMSI/5G-S-TMSI itself, Cell ID, ID of one or more RSs associated with the local device ID.

The local ruleset, according to examples, includes one or more inputs. The one or more inputs include, in one example, the first device ID based on which the UE is registered in the cellular NW. For example, the UE performs a modulus operation on the first device ID to determine the local device ID. By performing the modulus operation, the length of the first device ID is shortened and ambiguities are introduced. A cropping operation can be alternatively or additionally performed. I.e., a part of the long first device ID may be cropped/discarded. Thus, at least one subpart of the first device ID is used for constructing the short device ID. By performing the cropping operation, the length of the first device ID is shortened and ambiguities are introduced. By restricting the validity of the local device ID to the spatial context, here specifically the reception of the one or more RSs on the one or more beams—as discussed above in connection with box 3010—these ambiguities can be mitigated: the UE will only assume the local device ID to be valid as long as the spatial context is fulfilled.

For example, the local device ID can be the last X digits of the first device ID, e.g., TMSI. The last X digits are obtained in a cropping operation. For instance, with X=4 it would be possible to separate 64 Ues—if the spatial context is defined by 2 bits for beam ID and cell ID.

According to examples, the local ruleset is predefined, e.g., according to the communication protocol, e.g., the 3GPP specification. It would also be possible that the local ruleset is only partly predefined. Then, the local rules it can be determined based on further information obtained from the cellular NW. For example, the cellular NW can provide information that enables the UE to select the ruleset to apply for multiple candidate rulesets that are preconfigured and the UE. For example, the cellular NW can broadcast such information, e.g., in a system information, e.g., a 3GPP SIB message. For example, the information may pertain to the above-identified X value that specifies the number of last digits to be selected from the TMSI to determine the Local device ID.

An implementation using the local ruleset according to box 3022 corresponds to an implicit assignment of the local device ID. The cellular NW does not need to signal the local device ID explicitly. In this case, the UE expects the cellular NW (e.g, gNB) performs the same operation in generating the local device ID. This is in contrast to the scenario of box 3021. The scenario of box 3021 corresponds to an explicit assignment of the local device ID.

According to examples, the UE selects between box 3021 and box 3022—i.e., selects between explicit and implicit determination of the local device ID—, e.g., based on information broadcasted by the cellular NW or based on a local selection rule. The local selection rule can be specified in the communication protocol.

The local device ID is valid in association with the one or more RSs selected by the UE in box 3010. In another variant of the disclosure, the UE does not perform the selection in box 3010. The UE is provided with the selection of the one or more beams by the cellular NW. Likewise, the UE can be provided with the selection of one or more cells. For instance, the cellular NW can make such determination based on information regarding the position of the UE. In such a scenario, box 3020 further includes obtaining, from the cellular NW, an indication of the one or more RSs transmitted on the one or more beams that define the validity of the local device ID.

At box 3025, the UE may transition to the disconnected mode. In other examples, the UE may already operate in the disconnected mode when executing the preceding boxes. Transitioning to the disconnected mode can include releasing a data connection that is established between the UE and the cellular NW.

Respective aspects have been discussed above in connection with the data connection 189 established between the UE 101 and the radio access NW 111 of the cellular NW 100 in FIG. 1.

At box 3030, the UE determines whether it is located in coverage of or associated at least one of the one or more beams on which the one or more RSs are transmitted. In other words—and more generally—the UE determines whether the spatial context within which the local device ID is valid is still fulfilled.

Determining whether the UE is located in coverage of at least one of the one or more beams can be based on—box 3031—whether the one or more RSs (selected at box 3010 or provided by the cellular NW at box 3020) are received by the UE. In other words, when executing box 3030, the UE can attempt to receive the one or more RSs.

This can include—box 3031A—performing a threshold comparison between a received signal level of any given detected RS of the one or more RSs with a predefined received signal strength threshold. If the detected RS has a received signal level above the received signal strength threshold, the UE can assume that this RS is received.

Determining whether the UE is located in coverage of at least one of the one or more beams can be based on—box 3032—whether a location or association change of the UE is detected. There are different options available to detect a location change. In one example, the UE monitors for RSs; if previously unseen RSs are received, the UE can assume a location change. In a further example, the UE uses acceleration sensors to detect movement; if acceleration is detected, the UE can assume a location change. In a further example, the UE uses global positioning—e.g., satellite positioning—to detect a location change.

At box 3030, the UE can optionally determine whether it is located in at least one of the one or more cells of the cellular NW. As explained above, in addition to or as an alternative to a validity of the local device ID defined by one or more RSs transmitted on one or more beams, the validity of the local device ID can be defined by one or more RSs transmitted on one or more cells of the cellular NW. In other words, the local device ID is further valid in association with one or more cells of the cellular NW transmitting the one or more RSs on the one or more beams.

Determining whether the UE is located in the at least one of the one or more cells can depend on whether a location change of the UE is detected. This means that once a location change—as already discussed above in connection with box 3032—is detected, the UE may assume that it is not located in the same cell as previously located.

Determining whether the UE is located in at least one of the one or more cells can also be based on system information broadcasted by BSs of the cells of the cellular NW, as indicated in box 3033. The system information includes a cell ID of the broadcasting cell and the UE can check whether the cell ID included in the broadcasted system information block matches the cell ID of the one or more cells associated with the one or more beams on which the one or more RSs are transmitted.

As a general rule, the particular checks to be executed as part of box 3030 can be determined based on a mobility level of the UE. This is illustrated in connection with box 3034. For example, if the UE is stationary—i.e., has a low mobility level—the UE may not be required to monitor for the one or more RSs. The UE may also not be required to monitor for the cell ID. On the other hand, if the UE has a medium mobility level—i.e., moves within the same cell, but between beams of the cell—the UE may monitor for the one or more RSs, but may not be required to monitor for the cell ID. If the UE has a high mobility level, the UE may monitor, both, the cell ID, as well as the one or more RSs. In other words, the method may include—at box 3034—determining how to determine whether the UE is located in the coverage area of the one or more beams depending on a mobility level of the UE. Such a tailored check one whether the local device ID is still valid enables to reduce the power consumption of the UE. Unnecessary checks can be dispensed with.

If at box 3030, it is judged that the UE is in-coverage of at least one of the one or more beams on which the one or more RSs are transmitted, box 3010 and following are re-executed. In other words, an update of the local device ID is obtained. Upon obtaining this update, the local device ID is valid in association with other RSs transmitted on one or more other beams of the cellular NW, to account for the change in the spatial context of the UE.

If, on the other hand, at box 3030 it is judged that the UE is in coverage of at least one of the one or more beams on which the one or more RSs are transmitted, box 3035 is executed.

In an example, the local device ID is associated with a temporal validity. The temporal validity can specify a time duration during which the local device ID remains valid. The temporal validity could be specified in seconds or minutes.

At box 3035, the UE can determine whether the local device ID has expired, i.e., where the local device ID has exceeded its temporal validity. The UE can do so based on a local timer.

The temporal validity can be defined with respect to when the local device ID was obtained, i.e., when box 3020 was executed. The temporal validity can alternatively or additionally be defined with respect to when the UE last connected to the cellular NW. Such and other events can initialize a local timer maintained by the UE to perform the check of box 3035.

If the local device ID has expired, the method commences at box 3010. I.e., an update of the local device ID is obtained (as already explained above). Else, the method commences at box 3040.

At box 3040, the UE monitors whether a WUS transmitted by the cellular NW this indicative of the local device ID.

For example, the WUS may include the local device ID. The WUS may also otherwise indicate the local device ID. For instance, the WUS may be transmitted on resources—e.g., at a certain timing and/or at certain frequencies—that are determined based on the local device ID.

For example, the BS allocates four WUS resources (either frequency-division duplex, time-division duplex a combination thereof). The total bits of short ID is for example 8 bits (X1 X2 X3 X4 X5 X6 X7 X8). If a UE ID is 00 X3 X4 X5 X6 X7 X8 then that UE would only need to monitor the first WUS resource, subsequently if a UE ID is 01 X3 X4 X5 X6 X7 X8 then that UE would only need to monitor the second WUS resource, etc.

The UE, according to examples, attempts to receive the WUSs transmitted by the cellular NW and, upon detecting, a WUS transmitted by the cellular NW determines whether it is indicative the local device ID (or another local device ID allocated to another UE). It may also be indicative of the subsequent action from the UE after detecting the WUS.

The UE, according to examples, monitors for the WUS transmitted by the cellular NW in accordance with a predefined schedule. The UE can employ a discontinuous reception (DRX) cycle. The DRX cycle can be aligned with wake-up occasions at which the UE expects WUSs or aligned with time offset to reception of PEIs or paging DCIs, that may or may not include or be otherwise indicative of the local device ID.

In a scenario in which the time and/or frequency resources on which the WUS are predefined—e.g., relatively with respect to the one or more RSs associated with the local device ID—the cellular NW can reuse the same local device ID for other UEs—in particular, also UEs that are located in the same spatial context, e.g., in the coverage area of the same one or more beams of the same one or more cells. I.e., the same local device ID can be reused for UEs in the same spatial context, but employing orthogonal time resources or frequency resources. This allows an even higher reuse factor of the local device ID. In other words, the local device ID can be combined with concepts of frequency division multiplexing or time division multiplexing. Such scenario means that the local device ID also has a validity defined with respect to time resources and/or frequency resources.

The UE, according to examples, monitors for the WUS in time-frequency resources that are relatively defined with respect to time-frequency resources of the one or more RSs.

To give an example, the UE can detect a RS associated with the local device ID on a given time-frequency resource or resource set. Then, the UE can apply a predefined time offset and/or frequency offset to determine the time-frequency resource or time-frequency resource set during which the WUS is to be expected.

The UE can monitor for the WUS transmitted by the cellular NW at wake-up occasions.

The UE can monitor for the WUS using a LpRx. The UE can transition the low-power receiver from an inactive state to an active state prior term monitoring for the WUS. In the inactive state, the low-power receiver can be unfit to detect signals. In the inactive state, the low-power receiver can consume less power than in its active state.

The UE can monitor for the WUS using a main radio also used during the connected mode.

Upon detecting, at box 3045, that the WUS is indicative the local device ID, the UE, at box 3050 may optionally skip monitoring for further signals that would potentially include the first device ID. I.e., a fallback to wake-up procedure that is implemented based on the first device ID not implemented. The UE refrains for monitoring for other signals such as paging DCI or paging message.

This means, in other words, that a one-step wake-up procedure can be implemented. This reduces the overall energy consumption of the UE. This reduces a latency for the UE to take a subsequent action associated with the WUS.

At box 3055, the UE takes an action that is associated with the WUS that is received at box 3040/box 3045. Such action can be a random-access procedure to establish a data connection with the cellular NW, e.g., to transition to the connected mode. Such action can include transmission of uplink RSs, e.g., for positioning purposes. Such action can include reception of a mobile-terminating early data transmission provided by the cellular NW.

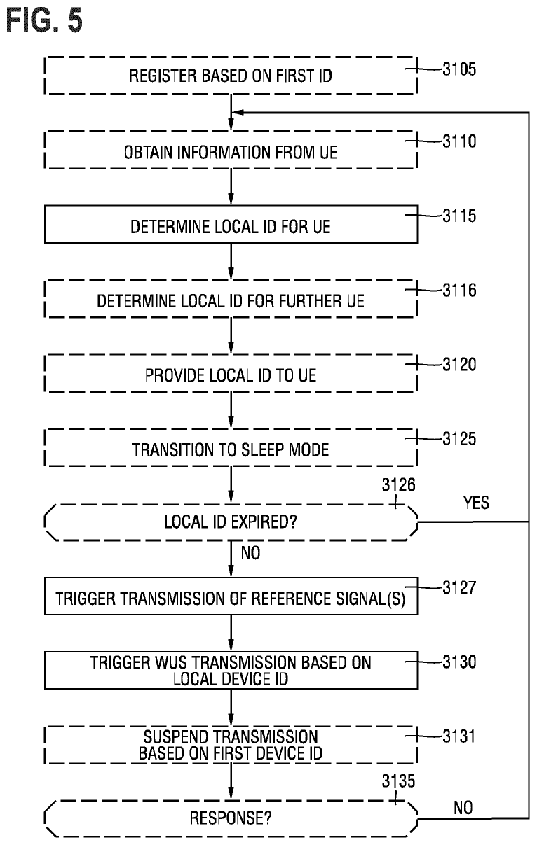

FIG. 5 is a flowchart of a method according to various examples. In FIG. 5, optional boxes are shown with dashed lines. The method of FIG. 5 is for use in a BS of a cellular NW. For example, the method of FIG. 5 can be used in the BS 112 (cf. FIG. 1). The method of FIG. 5 can be executed by the processor 1121 upon loading and executing program code from the memory 1122 (cf. FIG. 3).

While FIG. 5 is explained in connection with implementation in a BS, it would be equally possible that at least some steps of the method of FIG. 5 such as box 3115 are executed by another node of the cellular NW, e.g., a node of the CN of the cellular NW, e.g., an AMF (cf. FIG. 1: AMF 131).

At box 3105, a UE is registered in the cellular NW. This registration is based on a first device ID. The first device ID may be globally valid throughout the cellular NW. It can be a temporary device ID or a fixed device ID. It can be the 3GPP TMSI or IMSI or RNTI. Details with respect to the registration of the UE and the cellular NW as well as with respect to the first device ID have been previously explained in connection with box 3004 of the flowchart of the method of FIG. 4 and are equally applicable to box 3105.

At box 3110, the BS obtains information from the UE. This information is indicative of one or more RSs that the UE has selected. The UE selects such one or more RSs based on a selection rule. For instance, the UE can select the strongest RS or a number of strongest RSs. The UE can select the strongest RS or RSs of a certain type. The UE can select the strongest RSs transmitted by all neighboring BSs. Box 3110 corresponds to box 3015 of the method of FIG. 4.

There are different options for obtaining the information at box 3110. The BS can obtain information as part of a mobile-originating early data transfer that is transmitted by the UE during a random-access procedure of the UE.

In other scenarios, the selection of the one or more RSs is not made by the UE; but rathe by the BS. For instance, the BS can obtain measurement reports on a plurality of RSs from the UE. The BS can then select the one or more RSs based on the measurement reports. Selection criteria as previously discussed in connection with box 3010 of FIG. 4 can be equally applied.

Then, based on the information obtained from the UE at box 3110, the BS determines a second device ID that is hereinafter referred to as local device ID for the UE at box 3115.

The local device ID is shorter than the first device ID of box 3105.

This can be based on a local ruleset. The local ruleset can include one or more inputs, e.g., including the first device ID. The local ruleset may perform a modulus operation on the first device ID to determine the local device ID. Alternatively or additionally, a cropping operation is performed. In particular, the same local ruleset can be employed that is also employed by the UE in box 3022. Even in a scenario in which the UE does not employ a local ruleset at box 3022 to determine the local device ID (but rather obtains the local device ID from the cellular NW in box 3021), the aspects disclosed in connection with the ruleset at box 3022 are also valid for determining of the local device ID at the BS at box 3115.

The local device ID can be valid further in association with one or more cells of the cellular NW that transmit the one or more RSs. A cell list can be associated with the local device ID indicating those cells in which the local device ID is valid.

The BS may determine the one or more cells. The BS may also obtain an indication of the one or more cells from the UE.

When the BS determines the local device ID for the UE at box 3115, it can do so based on a list of duplicates that are valid in association with one or more further RSs transmitted on one or more further beams of the cellular NW. in other words, the BS—when determining the local device ID for the UE at box 3115—can be aware of the particular local device ID being already assigned to other UEs that are located in a different spatial context, i.e., on the one or more further beams. This means that the same local device ID can be re-used for multiple UEs that are located in coverage areas of different beams.

The local device ID is associated with the one or more RSs that are indicated by the UE in box 3110 or that are selected by the BS. These one or more RSs are transmitted on one or more beams of the cellular NW. For instance, these one or more beams may also be at least partly be associated with neighboring BS.

At optional box 3116, the same local device ID can be determined for another UE (cf. FIG. 1: UE 101 and UE 91). The other UE can be located in a different spatial context, i.e., can be located in a coverage area of different one or more further beams on which different RSs are transmitted. Alternatively or additionally, the other UE can be located in the same spatial context, i.e., can be located in the same coverage area of the one or more beams in which also the UE for which information is obtained at box 3110 is located. Then, WUSs for the two UEs can be transmitted on orthogonal time resources and/or orthogonal frequency resources. This means that the co-allocated device ID is valid in association with WUSs transmitted on orthogonal time resources and/or frequency resources. This corresponds to frequency and/or time multiplexing.

At box 3120, it is optionally possible to provide the local device ID to the UE for which it has been determined at box 3115. This is not necessary if the UE determines the local device ID based on a local ruleset (cf. FIG. 4: box 3022). An early data transmission can be used to provide the local device ID. Box 3120 corresponds to box 3021.

At box 3125, the UE may optionally transition to the disconnected mode (if it has not already been operating in the disconnected mode). Box 3125 can include providing a respective connection release message to the UE that releases a data connection that is established between the UE and the cellular NW when the UE operates in the connected mode. Box 3125 corresponds to box 3025.

In certain scenarios of the present disclosure, the local device ID has a temporal validity. In such scenarios, the BS, at box 3126 checks whether the local device ID is still valid. Respective techniques have been previously explained in connection with box 3035 in the method of FIG. 4. If the local device ID has expired, then the method commences at box 3110; so that an update of the local device ID can be determined.

At box 3127, transmission of one or more RSs is triggered. The one or more RSs is not necessarily event-triggered. It can be the periodic reference signal(s) that has been configured to be transmitted periodically. Box 3127 can include transmitting the one or more RSs and/or providing respective instructions to one or more BSs (e.g., if box 3127 is executed by a CN node of the cellular NW). The one or more RSs can be transmitted on predefined time-frequency resources.

Example RS include 3GPP CSI-RS or 3GPP SSB or 3GPP PRS, or potentially LP-SYNC signal. The one or more RSs are identified by a certain identifier carried by the RSs; and/or by certain time-frequency resources.

At box 3130, one or more transmissions of a WUS indicative of the local device ID are triggered on a least one of the one or more beams that are associated with the local device ID (as explained above in connection with box 3115). Triggering the one or more transmissions of the WUS can include providing respective instructions to one or more BS and/or transmitting the WUS.

The transmission of the WUS can be in accordance with a timing schedule. The transmission can be on time resources and/or frequency resources that are allocated to the WUS. The transmission can be at wake-up occasions. The transmission can be a time-frequency resources that are relatively defined with respect to time-frequency resources that are relatively defined with respect to time-frequency resources at which the one or more RSs are transmitted at box 3127, i.e., at a certain time and/or frequency offset.

Upon triggering the transmission of the WUS at box 3130, at box 3131, transmission of the WUS or a further WUS including the first device ID can be suspended. I.e., the wake-up procedure is (at least initially) implemented based on the local device ID (but not on the first device ID). For instance, where it is attempted to reach the UE based on the local device ID, it is not required to provide paging messages to the UE that include the UE TMSI. The use of the first device ID can be suspended with, e.g., until determining that the UE does not take the action that is triggered by the WUS that includes or is otherwise indicative of the local device ID. The use of the first device ID can be suspended with until determining that the UE does not respond to the local device ID. This enables to implement a compact wake-up procedure, e.g., a one-step wake-up procedure. Power consumption at the UE is reduced.

At box 3135, upon triggering the one or more transmissions of the WUS, the BS monitors whether the UE takes an action that is associated with the WUS that includes the local device ID. Example actions have been explained above in connection with box 3055 and include, amongst others: the UE performing a random-access procedure; the UE transmitting uplink RSs; the UE receiving a mobile-terminating early data transmission.

If the UE does not take the action, it is judged that the UE cannot be reached by the WUS that includes or is otherwise indicative of the local device ID. Then, one or more further transmissions of one or more further WUSs including the first device ID could be triggered. Alternatively, box 3110 is re-executed to thereby determine an update of the local device ID. The scenarios illustrated in FIG. 5. The update takes into consideration the new spatial context of the UE. I.e., one or more beams having a coverage area in which the UE is located are predetermined.

Summarizing, it has been disclosed how to allocate a temporary device ID to a UE. The temporary device ID that is associated with a RS transmitted by a BS when the UE is not in a connected mode. The temporary device ID accordingly is a local device ID that uniquely identifies the UE while the UE is in-coverage of the RS.

The purpose of a temporary device ID is to be able to address the UE with fewer bits (e.g., lower than the required number of bits for TMSI/5G-S-TMSI/I-RNTI), but still uniquely being able to identify the UE.

Avoidance of ambiguities between multiple UEs registered in the same cellular NW and sharing the same temporary device ID is achieved by narrowing down the area where UEs with same temporary ID are allowed reside.

In an example, the spatial context is defined by a cell or group of cells where the UE can receive the local device ID. This is explained in connection with 3030. In a further example, the spatial context is defined by one or more RSs. The one or more RSs are transmitted on one or more beams of the cellular NW. This is explained in connection with 3030.

By combining a short temporary local device ID with one or more cells and beam information of one or more RS, it is possible to limit the area to uniquely address the UEs to a subregion of cells. I.e., the spatial granularity with which the spatial context can be defined is finer than by merely using cell IDs.

To enable the local device ID, knowledge where the UE is located is used. Time information when the UE was lastly connected to the NW can be used. This is in particular helpful where the local device ID has a temporal validity. This is explained in connection with box 3035.

To enable the local device ID, further knowledge of the mobility of the UE can be used to determine whether the UE has moved of the coverage of the one or more beams or generally the spatial context associated with the local device ID. The UE can use a certain RS to identify its whereabout. While the UE receives the RS according to the, the UE is woken up by the cellular NW by detecting the local device ID in the configured time event, similar to discontinues reception.

The temporary local device ID is valid until one or more invalidity criteria are met.

From the perspective of the cellular NW, the temporary local device ID is only valid as long as the UE response to the WUS or the low-power signaling sent by BS. The temporary local device ID is no longer valid if the UE does not respond to the WUS sent by BS. For example, N times after the BS transmits the WUS or low-power signaling without a response from the UE, the temporary local device ID is not valid for the UE any longer. E.g., N=3.

From perspective of the UE, the temporary local device ID can only be valid as long as the signal level of the associated RS (e.g., SSB) is above the threshold. This is explained in box 3031A. If the signal level of the associated RS is below threshold in N number of measurements. E.g., N=3. The temporary ID is no longer valid. If the temporary ID is no longer valid, the UE needs to acquire new temporary ID (cf. feedback loop in FIG. 3)

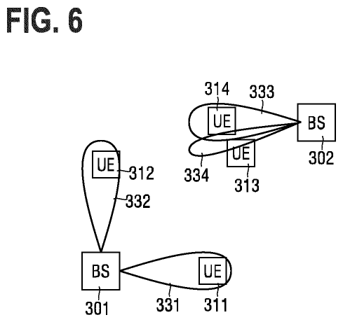

FIG. 6 illustrates allocation of a local device ID to multiple UEs 311-314.

The cellular NW 100 includes the BS 301 and the BS 302. The same local device ID is allocated to all UEs 311-314 contemporaneously. Transmission of WUSs that include or are otherwise indicative of the same local device ID is limited to the respective beams 331-334 associated with the local device ID.

For instance, the local device ID allocated to the UE 311 is associated with RSs transmitted on the beam 331. The same local device ID is also allocated to the UE 312, but that in association with RSs transmitted on the beam 332. The same local device ID is also allocated to the UE 313, but then two RSs transmitted on the beam 334 and on the beam 333. The same local device ID is also allocated to the UE 314, but then in association with the RSs transmitted on the beam 333.

The local device ID is associated with one or more RSs and a cell ID.

The RS(s) can be identified by an ID, for instance, the SSB can be identified by SSB_ID, up to 64.

The RS can be the SSB (synchronization signal), CRS, and/or PRS.

There is a mapping between the information bit in each field and a sequence suitable to being detected by a low-power receiver.

TAB. 1 summarizes the assignment of local device IDs with RS(s) and cell IDs in the scenario of FIG. 6.

TABLE 1
Example of assignment of a single local device ID
to multiple UEs in different spatial contexts.

| UE | Local device ID | RS 1 | RS 2 | Cell ID |
|---|---|---|---|---|
| 311 | “100” | “4” (SSB) | Not defined | “20” |
| 312 | “100” | “3” (SSB) | Not defined | “20” |
| 313 | “100” | “3” (SSB) | Not defined | “5” |
| 314 | “100” | “2” (SSB) | “6” (PRS) | “5” |

Thus, as explained in connection with TAB. 1 but more generally, the cellular NW 100 allocates a locally valid second device ID to a first UE and to a first spatial context, the first UE being registered to the cellular NW using a first globally valid device ID. While the locally valid second device ID is allocated to the first UE and the first spatial context, the cellular NW also allocates the same locally valid device ID to a second UE and a second spatial context, the second UE registered to the cellular NW using a second globally valid device ID that is different than the first globally valid device ID, the second spatial context being different than the first spatial context. Then, when the cellular NW attempts to reach the first UE operating in a disconnected mode, a first transmission of WUSs is triggered, the first transmission including the locally device ID, the first transmission being limited to the first spatial context. Also, when attempting to reach the second UE operating in the disconnected mode, a second transmission of the WUSs that include the locally valid device ID, the second transmission being limited to the second spatial context. Here, the spatial context is defined by one or more beams of the cellular NW and optionally by one or more cells of the cellular NW.

Summarizing, at least the following EXAMPLES have been disclosed:

EXAMPLE 1. A method for use in a wireless communication device registered (3005) in
a cellular network based on a first device identifier, the method comprising:
obtaining (3020) a second device identifier valid in association with one or more reference signals transmitted on one or more beams of the cellular network, the second device identifier being different than the first device identifier,
upon the wireless communication device being located in coverage of at least one of the one or more beams on which the one or more reference signals are transmitted and while the wireless communication device operates in a disconnected mode, monitoring (3040) whether a signal transmitted by the cellular network is indicative of the second device identifier, and
upon detecting that the signal is indicative of the second device identifier, taking (3055) an action associated with the signal.

EXAMPLE 2. The method of EXAMPLE 1, further comprising:
determining (3030) whether the wireless communication device is located in coverage of the at least one of the one or more beams on which the one or more reference signals are transmitted based on whether the one or more reference signals are received (3031) at the wireless communication device.

EXAMPLE 3. The method of EXAMPLE 1 or 2,
wherein the second device identifier has a temporal validity.

EXAMPLE 4. The method of any one of the preceding examples, further comprising
upon to detecting that the signal comprises the second device identifier, refrain from (3050) monitoring for a paging signal.

EXAMPLE 5. The method of any one of the preceding examples, further comprising:
providing (3015), to the cellular network, information indicative of the one or more reference signals transmitted on one or more beams of the cellular network.

EXAMPLE 6. The method of any one of the preceding examples, further comprising:
performing (3010) channel measurements based on a plurality of reference signals transmitted on a plurality of beams and selecting the one or more reference signals from the plurality of reference signals based on the channel measurements.

EXAMPLE 7. The method of any one of the preceding examples,
wherein said obtaining (3020) of the second device identifier comprises obtaining (3021), from the cellular network, at least a part of the second device identifier.

EXAMPLE 8. The method of any one of the preceding examples,
wherein said obtaining (3020) of the second device identifier comprises determining (3022) at least a part of the second device identifier based on a local ruleset.

EXAMPLE 9. A method for use in a node of a cellular network, a wireless communication device being registered (3105) to the cellular network based on a first device identifier, the method comprising:
determining (3115) a second device identifier for the wireless communication device, the second device identifier being valid in association with one or more reference signals transmitted on one or more beams of the cellular network, the second device identifier being different than the first device identifier,
while the wireless communication device operates in a disconnected mode: triggering (3130) one or more transmissions of a signal indicative of the second device identifier on at least one of the one or more beams.

EXAMPLE 10. The method of EXAMPLE 9, further comprising,
determining (3116) another second device identifier for another wireless communication device, the another second device identifier being the same as the second device identifier, the another second device identifier being valid in associated with one or more further reference signals transmitted on one or more further beams of the cellular network, the one or more further reference signals being different than the one or more reference signals, the one or more further beams being different than the one or more beams.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, techniques have been disclosed in which a local device ID is tied to a certain spatial context. In particular, scenarios have been disclosed in which the local device ID is associated with one or more RSs that are transmitted on one or more beams of a cellular NW. In some scenarios, the spatial context may be defined differently than the association of the local device ID with the one or more RSs that are transmitted on one or more beams. For instance, the spatial context can be defined only based on the cell ID of a cell. Alternatively or additionally, the local device ID is valid in a certain geo-fenced area. For instance, a geo-fenced area can be defined by a grid of latitude-longitudinal nodes and as long as the UE remains within the geo-fenced area, it can assume that the local device ID remains valid. Alternatively or additionally, the local device ID is valid as long as the UE is being served via a certain coverage-enhancing device. For instance, the local device ID remains valid as long as it is being served via a certain repeater.

For further illustration, above, techniques have been disclosed in which a local device ID is tied to a certain spatial context. Beyond such association of a local device ID to a certain spatial context, unique device IDs could also be obtained by association to specific time resources or specific frequency resources, e.g., sub-bands or bandwidth parts. Such time resources and/or frequency resources may be relatively defined with respect to one or more RSs associated with the device ID.

For further illustration, above scenarios have been disclosed in which the UE monitors whether a WUS that is transmitted by the cellular NW includes a device identifier and upon detecting that the WUS includes the device identifier takes an associated action. According to examples, such signal can take other forms than a WUS. For instance, such signal may be transmitted on the PDCCH and even be detected by a main radio of the UE.

For still further illustration, above, various scenarios have been disclosed in which a signal carries (i.e., includes) a device ID that is locally valid in a spatial context. Similarly, these techniques can also be used for a signal that is otherwise indicative of such device ID that is locally valid in the spatial context. For instance, such signal—e.g., a WUS—can be transmitted on certain time and/or frequency resources that are associated with the locally valid device ID. Different locally valid device IDs would then be associated with different time and/or frequency resources.

1. A method for use in a wireless communication device registered in a cellular network based on a first device identifier, the method comprising:
obtaining a second device identifier valid in association with one or more reference signals transmitted on one or more beams of the cellular network, the second device identifier being different than the first device identifier,
upon the wireless communication device being located in coverage of at least one of the one or more beams on which the one or more reference signals are transmitted and while the wireless communication device operates in a disconnected mode, monitoring whether a signal transmitted by the cellular network is indicative of the second device identifier, and
upon detecting that the signal is indicative of the second device identifier, taking an action associated with the signal.

2. The method of claim 1, further comprising:
determining whether the wireless communication device is located in coverage of the at least one of the one or more beams on which the one or more reference signals are transmitted based on whether the one or more reference signals are received at the wireless communication device.

3. The method of claim 2, further comprising:
performing a threshold comparison between any detected reference signal of the one or more reference signals and a predefined received signal strength threshold, and
determining whether the one or more reference signals are received based on the threshold comparison.

4. The method of claim 1, further comprising:
determining whether the wireless communication device is located in coverage of the at least one of the one or more beams on which the one or more reference signals are transmitted depending on whether a location change of the wireless communication device is detected.

5. The method of claim 1, further comprising:
upon the wireless communication device not being located in coverage of the one or more beams on which the one or more reference signals are transmitted and while operating in the disconnected mode, obtaining an update of the second device identifier valid in association with one or more further reference signals transmitted on one or more further beams of the cellular network.

6. The method of claim 1,
wherein the action comprises a random-access procedure.

7. The method of claim 1,
wherein the action comprises at least one of a transmission of uplink reference signals or reception of a mobile-terminating early data transmission.

8. The method of claim 1,
wherein the first device identifier is longer than the second device identifier.

9. The method of claim 1,
wherein the first device identifier is globally valid throughout the cellular network.

10. The method of claim 1,
wherein the first device identifier is a Third Generation Partnership Project (3GPP), Temporary Mobile Subscriber Identity (TMSI).

11. The method of claim 1,
wherein the one or more reference signals comprise Third Generation Partnership Project (3GPP), Synchronization Signal Blocks (SSB),
wherein an SSB burst comprises transmission of a plurality of SSBs on a plurality of beams, the plurality of beams comprising the one or more beams.

12. The method of claim 1,
wherein the one or more reference signals are selected from the group comprising: Third Generation Partnership Project (3GPP), Channel State Information Reference Signals (CSI-RS), 3GPP Tracking Reference Signals (TRS), or 3GPP Positioning Reference Signals (PRS).

13. The method of claim 1,
wherein the one or more reference signals are identified by at least one of one or more identifiers included in the one or more reference signals, or by pre-allocated time-frequency resources on which the one or more reference signals are transmitted.

14. The method of claim 1,
wherein the second device identifier has a temporal validity.

15. The method of claim 1,
wherein the signal is transmitted at least one of a predefined time offset or a predefined frequency offset with respect to the one or more reference signals.

16. The method of claim 1, further comprising:
upon to detecting that the signal comprises the second device identifier, refrain from monitoring for a paging signal.

17. The method of claim 1, further comprising:
providing, to the cellular network, information indicative of the one or more reference signals transmitted on one or more beams of the cellular network.

18. The method of claim 1, further comprising:
performing channel measurements based on a plurality of reference signals transmitted on a plurality of beams and selecting the one or more reference signals from the plurality of reference signals based on the channel measurements.

19. The method of claim 1,
wherein said obtaining of the second device identifier comprises obtaining, from the cellular network, at least a part of the second device identifier.

20-27. (canceled)

28. A method for use in a node of a cellular network, a
wireless communication device being registered to the cellular network based on a first device identifier, the method comprising:
determining a second device identifier for the wireless communication device, the second device identifier being valid in association with one or more reference signals transmitted on one or more beams of the cellular network, the second device identifier being different than the first device identifier,
while the wireless communication device operates in a disconnected mode: triggering one or more transmissions of a signal indicative of the second device identifier on at least one of the one or more beams.

29-51. (canceled)
